(19) United States
(12) Patent Application Publication
(10) Pub. No.: US 2011/0193390 A1
(43) Pub. Date: Aug. 11, 2011

(54) LOCATING MEMBER FOR LOCATING SCOOTER SEAT

(75) Inventor: CHEN-CHI HSIAO, CHIA YI CITY (TW)

(73) Assignee: SUNPEX TECHNOLOGY CO., LTD., CHIA YI CITY (TW)

(21) Appl. No.: 12/704,059

(22) Filed: Feb. 11, 2010

(51) Int. Cl. B60N 2/14; A47C 3/18

(52) U.S. Cl. 297/344.22

(57) ABSTRACT

A locating member for locating scooter seats is revealed. The locating member includes a seat and a support rod, pivoted to each other. A control rod disposed with a locking part and a returning member is pivoted to the seat. The other end of the returning member is fixed on the seat. The support rod is arranged with a locating disk. The locking part of the control rod is locked into a locating part of the locating disk so as to fix the seat at a proper position with the required angle. Thus users can ride scooters conveniently. Moreover, two ends of the control rod away from a pivot region are respectively disposed with a first grip and a second grip and users can choose freely one grip to pull the control rod. Thus the elderly, the disabled and even the handicapped can operate and rotate the seat conveniently.

### BACKGROUND OF THE INVENTION

1. Fields of the Invention

The present invention relates to a locating member for locating scooter seats, especially to a locating member that fixes a seat at a proper position so as to make users ride the scooter more conveniently.

2. Descriptions of Related Art

Generally, scooters are vehicles with at least one storage cell and a direct current (DC) motor. The storage cell provides electricity to the DC motor for generating mechanical power that drives the scooters. During conversion processes in which electrical energy is converted to kinetic energy, nearly no side products are generated except little frictional heat energy. Moreover, beside some unavoidable noises generated by friction of machine parts, the sound level generated by normal operation of the electric motor is quite low, compared with noises generated by internal combustion engine. Thus scooters are transportation vehicles without pollution and with small noises. Now scooters are mainly used for helping old people and the disabled in their mobility requirements. They are also used as golf carts designed to carry golfers and their golf clubs.

For easy ride on scooters, the seat can be rotated 90 degrees and located in one of four positions, front, back, left and right after being connected with a vehicle body of the scooter. Refer to Taiwanese App. Pub. No. M282662-“locating member for locating scooter seat”, a scooter includes a bump extended from a center of a bottom plate of a seat. An elastic control rod is arranged on the bump. The control rod can move back to its original position after being pulled up. As to a seat tube in an housing extended from and fixed on the vehicle body, a round top block is arranged thereon so as to assemble with the bump of the seat. Moreover, a slot for mounting a front end of the control rod is respectively arranged on a front position and a back position on a circumference of the round top block. Each of two sides of the front end of the control rod is a bevel edge, corresponding to the other side.

However, in use, the seat is located by the control rod on one side of the scooter seat mounted into the slot on the circumference of the round top block. Most of the users are old people, the disabled and even the handicapped and they may have difficulties in operating the control rod. Thus they still need assistance from others while riding the scooter. This leads to disturbance in use.

### SUMMARY OF THE INVENTION

Therefore it is a primary object of the present invention to provide a locating member for locating scooter seat in which a control rod of a seat is disposed with a locking part while a locating part is formed on a locating disk so that the seat is rotated a certain degree and is fixed at a required position. Thus users can ride scooters conveniently. Moreover, users can choose each of the two ends of the control rod to pull the control rod according to their needs. The operation and rotation of the seat is convenient for the elderly, the disabled and even the handicapped.

In order to achieve above object, a locating member for locating scooter seats includes a seat and a support rod. The seat is arranged with a bottom plate. A connection tube is extended downward from a center of the bottom plate to be assembled with the support rod. A control rod is pivoted beside the connection tube and is having a locking part arranged projectingly and correspondingly to the connection tube. The locking part is locked in a locating part on a circumference of a locating disk. Moreover, two ends of the control rod away from a pivot region are respectively disposed with a first grip and a second grip. Thus users can choose each of two ends freely to pull the control rod. And one end of a returning member is fixed on the control rod while the other end thereof is arranged on the bottom plate. The returning member can be a spring. Thus the control rod can move back to its original position after being pulled.

As to the support rod, it includes a connection part for pivoting to the connection tube on the bottom of the seat and a locating disk fixed around the top end thereof. A plurality of locating parts such as openings is arranged at a circumference of the locating disk so as to lock and fix the locking part of the control rod. Thus the seat is located after being rotated.

The locking part can be a projecting block and the locating part is a corresponding opening on the circumference of the locating disk.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a top view of an embodiment in a located state according to the present invention;

FIG. 3 is a lateral cross-sectional view of an embodiment in a located state according to the present invention;

FIG. 4 is a top view of an embodiment that is not located according to the present invention;

FIG. 5 is a lateral cross-sectional view of an embodiment that is not located according to the present invention.

### DETAILED DESCRIPTION OF THE PREFERRED EMBODIMENT

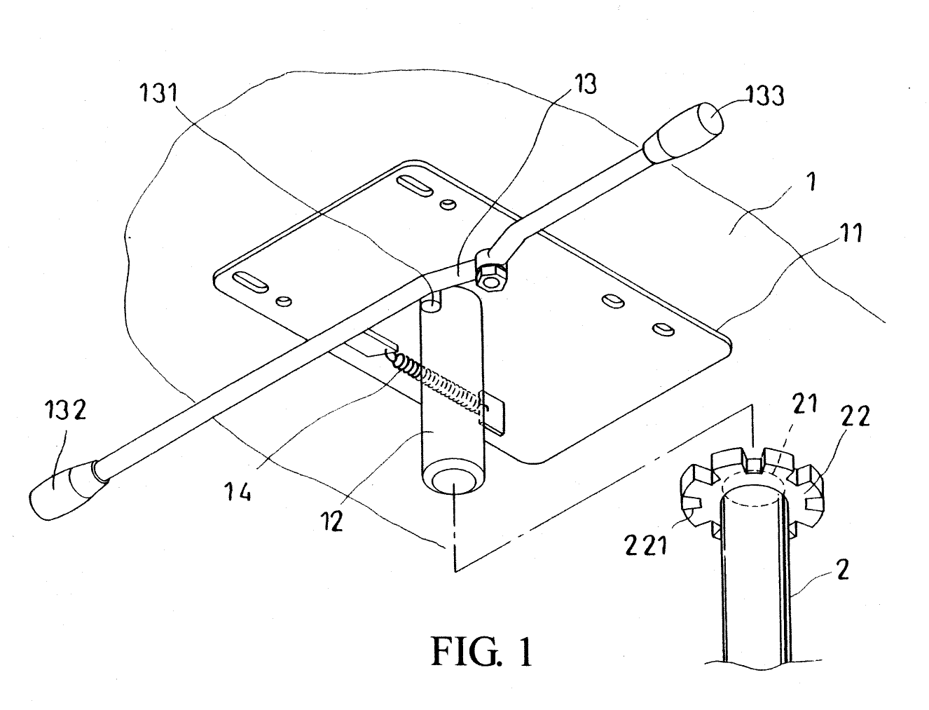

Refer to FIG. 1, a locating member for locating scooter seats includes a seat 1 and a support rod 2.

A bottom plate 11 is fixed on a bottom of the seat 1 and a connection tube 12 for being pivoted to the support rod 2 extended downward from a center of the bottom plate 11. A control rod 13 is pivoted beside the connection tube 12 correspondingly. A locking part 131 such as a projecting block is disposed projectingly on the control rod 13, corresponding to the connection tube 12, and is used to lock in a locating part 221 around a locating disk 22. Moreover, the control rod 13 includes a first grip 132 and a second grip 133 respectively disposed on two ends thereof, away from a pivot region. Thus users can choose freely one of the two sides to pull the control rod 13. Furthermore, one end of a returning member 14 is connected with and fixed on the control rod 13 while the other end of the returning member 14 is disposed on the bottom plate 11. The returning member 14 can be a spring. Thus after being pulled, the control rod 13 can be turned back to the original position.

A connection part 21 for pivoting to the connection tube 12 on the bottom of the seat 1 is formed on a top end of the support rod 2. The connection part 21 can be a sleeve hole while a locating disk 22 is disposed around the top end of the support rod 2. A plurality of locating parts 221 such as openings is arranged at a circumference of the locating disk 22 so as to lock and fix the locking part 131 of the control rod 13. Thus the seat 1 can be located after being rotated.

While assembling, refer from FIG. 1 to FIG. 3, the connection tube 12 on the bottom of the seat 1 is sleeved into the connection part 21 on the top end of the support rod 2 so that the seat 1 can rotate a full 360 degrees on top of the support rod 2. And the locking part 131 of the control rod 13 is locked into one of the locating part 221 on the circumference of the locating disk 22 so as to fix the angle of the seat 1.

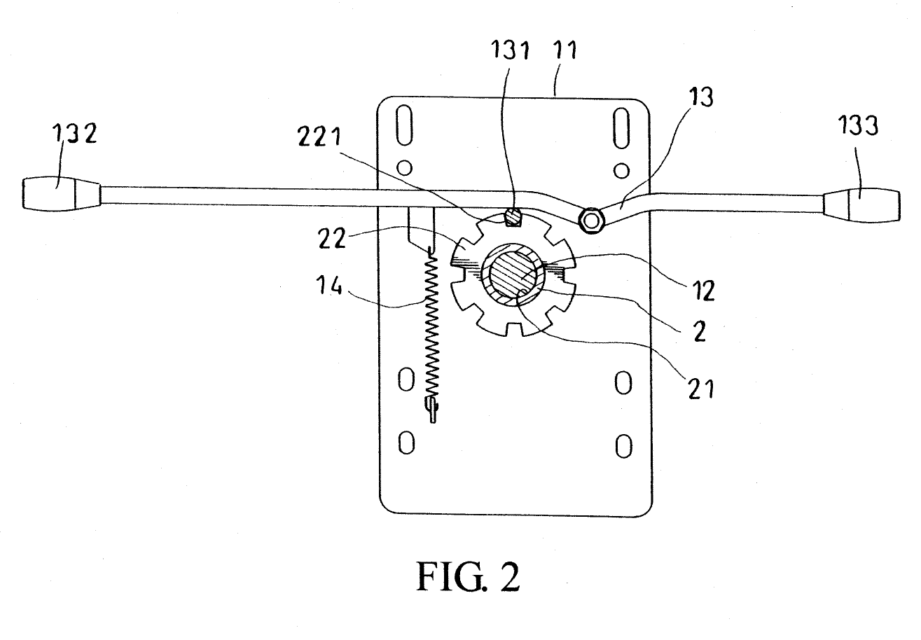

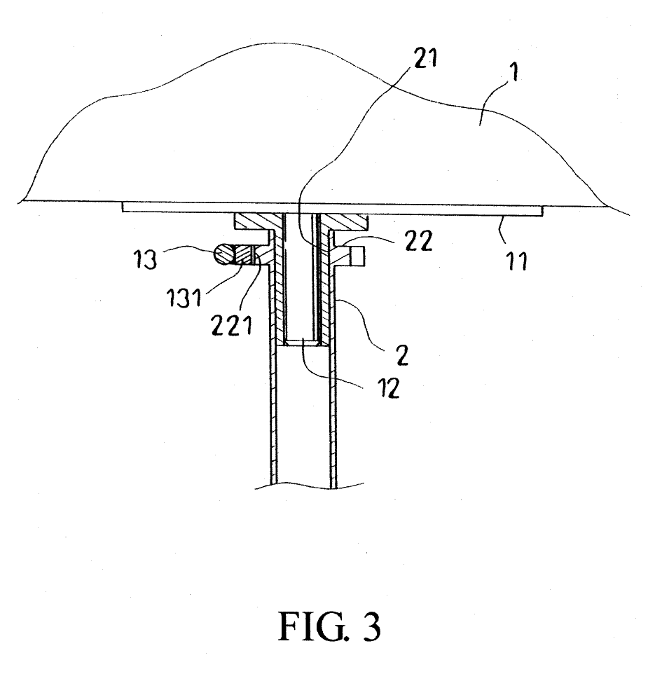

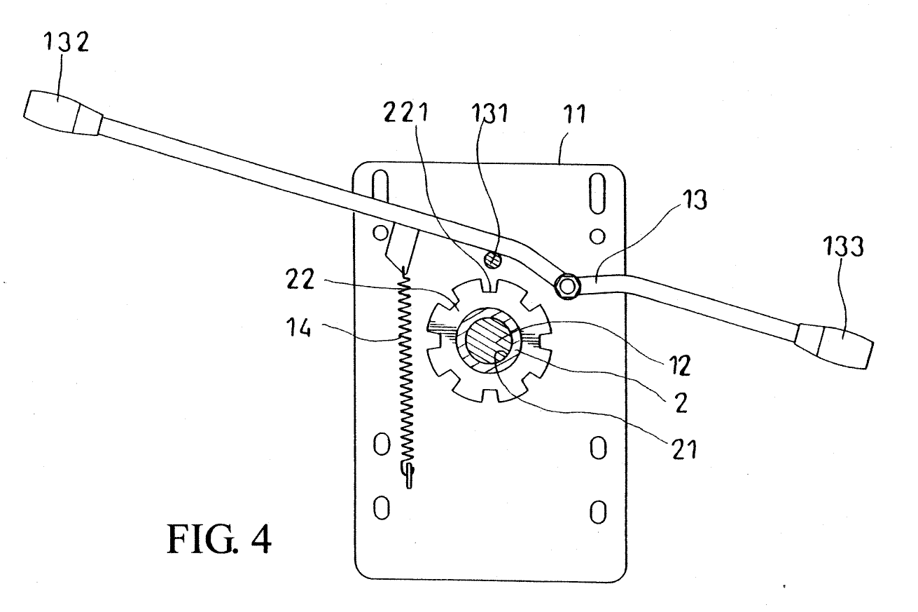

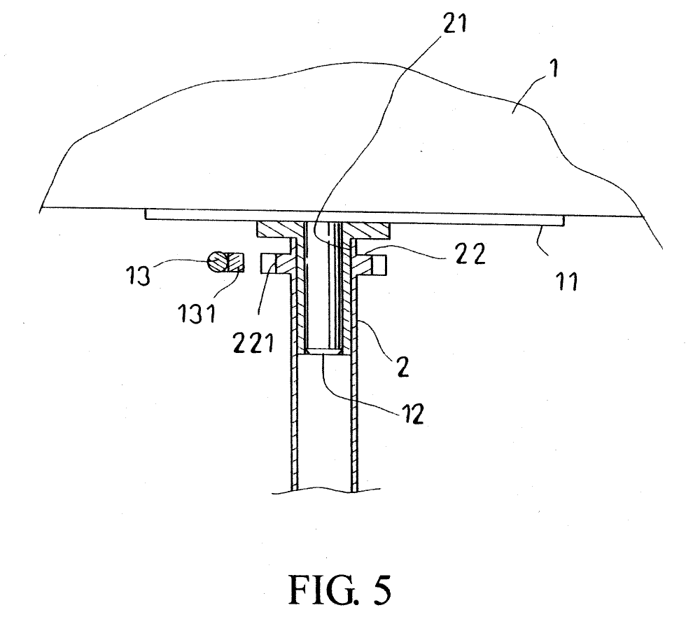

In use, refer to FIG. 2 and FIG. 3, the seat 1 is rotated to a position facing outwards for users' convenience to sit thereon. After the user sits on the seat 1, refer to FIG. 4 and FIG. 5, pull the first grip 132 (or the second grip 133) of the control rod 13 so as to make the control rod 13 rotate around the pivot region and further drive the locking part 131 releasing from the locating part 221 of the locating disk 22. Then the seat 1 is turned back to the state facing forward and is ready for users to sit and drive the scooter. After the seat 1 being turned back, release the first grip 132 (or the second grip 133) of the control rod 13 and the control rod 13 is turned back to it original position and is forced to be locked into a corresponding locating part 221 of the locating disk 22 by elasticity of the returning member 14. Thus the seat 1 is located at a position facing forward and the scooter is ready to ride. Thereby the user can ride the scooter safely and conveniently. Moreover, the control rod 13 is disposed with the first grip 132 and the second grip 133. Thus the user can choose to pull one of the two grips as they required. This enhances the convenience of operating and rotating the seat 1 for older people, the disabled and even the handicapped.

Compared with the structure available now, the present invention has following advantages:

1. The control rod is pivoted to the seat while the support rod under the control rod and under the seat is arranged with the locking part and locating part correspondingly. Thus the rotation angle of the seat can be fixed as required for the convenience of users while riding scooters.
2. Two ends of the control rod of the present invention are respectively disposed with the first grip and the second grip so that users can choose one of the grips according to their needs to pull the control rod. Thus the operation and rotation of the seat become convenient for old people, the disabled, even the handicapped.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A locating member for locating scooter seats comprising a seat and a support rod pivoted to each other, wherein
the seat is pivoted with a control rod while the control rod is disposed with a locking part corresponding to the support rod and a returning member and two ends of the control rod away from a region pivoted with the seat are respectively arranged with a first grip and a second grip; the other end of the returning member is arranged at the seat;
the support rod is arranged with a locating disk;
the locking part of the control rod is locked into a locating part on the locating disk.

2. The device as claimed in claim 1, wherein a bottom plate is fixed on the seat and a connection tube is arranged at the bottom plate while a connection part is arranged at the support rod; the connection tube is sleeved in and connected with the connection part.

3. The device as claimed in claim 2, wherein the other end of the returning member is fixed on the bottom plate.

4. The device as claimed in claim 3, wherein the returning member is a spring.

5. The device as claimed in claim 3, wherein the locking part is a projecting block and the locating part is an opening corresponding to the projecting block.

6. The device as claimed in claim 2, wherein the returning member is a spring.

7. The device as claimed in claim 2, wherein the locking part is a projecting block and the locating part is an opening corresponding to the projecting block.

8. The device as claimed in claim 1, wherein the returning member is a spring.

9. The device as claimed in claim 1, wherein the locking part is a projecting block and the locating part is an opening corresponding to the projecting block.
